(19) United States
(12) Patent Application Publication
(10) Pub. No.: US 2002/0025395 A1
(43) Pub. Date: Feb. 28, 2002

(54) Shoe outsole

(76) Inventor: Ikuko Umezawa, Kobe-shi (JP)

Correspondence Address: BIRCH STEWART KOLASCH & BIRCH, PO BOX 747, FALLS CHURCH, VA, 22040-0747, US

(21) Appl. No.: 09/877,115

(22) Filed: Jun. 11, 2001

(30) Foreign Application Priority Data
Jun. 23, 2000 (JP) 2000-190034

(51) Int. Cl. B32B 1/02

(52) U.S. Cl. 428/35.7

(57) ABSTRACT

A shoe outsole (1) is formed of a rubber composition including a short fiber. The amount of the short fiber to be blended is 2 to 40 parts by weight for 100 parts by weight of a base rubber. The short fiber has an orientation in an almost horizontal direction. An orientation angle to the horizontal direction of the short fiber is 30 degrees or less. The short fiber may have an orientation in almost horizontal and lateral directions. Moreover, the short fiber may have an orientation in almost horizontal and longitudinal directions. The outsole (1) is excellent in a strength.

### BAGKCROUND OF THE INVENTION

1. Field of the Invention

The present invention relates to shoes such as tennis shoes, golf shoes, soccer shoes, jogging shoes, trekking shoes or town shows, and outsole to be used for the shoes.

2. Description of the Related Art

A shoe has an outsole forming a bottom face thereof. The outsole is usually formed of a polymer composition having a rubber or the like as a base material. Important demand performance for the outsole includes difficulty of slipping out of a ground, that is, a good gripping property. In order to enhance the gripping property, the outsole has conventionally been devised variously. For example, Japanese Patent No. 2957480 has disclosed an outsole having the gripping property enhanced through the use of a specific rubber. Japanese Utility Model No. 2602710 has disclosed an outsole in which a short fiber has an orientation in a vertical direction (that is, a direction perpendicular to a ground face), resulting in an enhancement in the gripping property.

Another demand performance for the outsole includes a high strength. Various efforts have been made to enhance the strength. However, the strength can still be improved.

### SUMMARY OF THE INVENTION

In consideration of such circumstances, it is an object of the present invention to provide an outsole having a sufficient strength and a shoe comprising the outsole.

In order to achieve the above-mentioned object, the present invention provides an outsole formed of a polymer composition having 2 to 40 parts by weight of a short fiber blended for 100 parts by weight of a base polymer, the short fiber having an orientation in an almost horizontal direction.

In the outsole, 2 to 40 parts by weight of a short fiber is blended and has an orientation in the almost horizontal direction, so the short fiber is excellent in a strength (particularly, a tensile strength in the horizontal direction). In this specification, a numeric value indicated as “part” represents a ratio based on a weight.

A preferable short fiber includes a glass fiber which is comparatively rigid and has a high degree of design freedom of bending anisotropy which will be described below in detail, and an aramid fiber having a high strength and a high abrasion resistance.

In the present invention, the short fiber may have an orientation in almost horizontal and lateral width directions. Consequently, the outsole is easily bent in a longitudinal direction of a shoe and is bent with difficulty in the lateral direction of the shoe. Accordingly, the shoe has a good wear feeling compatible with a stability.

In the present invention, the short fiber may have an orientation in almost the horizontal and longitudinal directions. Consequently, a specific strength can particularly be enhanced in the longitudinal direction. Accordingly, the weight of the outsole can be reduced.

It is preferable that the short fiber should have an orientation angle of 30 degrees or less, particularly 25 degrees or less to a horizontal direction (with respect to a ground face). Consequently, it is possible to obtain a sufficient tensile strength in the horizontal direction.

The outsole in which the short fiber having an orientation in almost the horizontal and lateral directions is obtained by using a polymer composition which is formed like a sheet through extrusion or rolling (so-called tight milling) and thus includes a short fiber having an orientation in a specific direction and by setting the orientation to be almost coincident with the lateral direction.

The outsole including the short fiber having an orientation in almost the horizontal and longitudinal directions is obtained by using a polymer composition which is formed like a sheet through the extrusion or rolling and thus includes a short fiber having an orientation in a specific direction and by setting the orientation to be almost coincident with the longitudinal direction.

### BRIEF DESCRIPTION OF THE DRAWINGS

FIG. 1 is a bottom view showing an outsole according to an embodiment of the present invention,

FIG. 2 is a typical diagram showing a method of measuring a fiber angle in a horizontal direction of a short fiber,

FIG. 3 is a typical bottom view showing the outsole illustrated in FIG. 1,

FIGS. 4A and 4B are bottom and perspective views showing a cylinder punched out of the outsole illustrated in FIG. 3, and

FIG. 5 is a perspective view showing a specimen obtained from the cylinder illustrated in FIGS. 4A and 4B.

### DESCRIPTION OF THE PREFERRED EMBODIMENTS

The present invention will be described below in detail based on preferred embodiments with reference to the drawings.

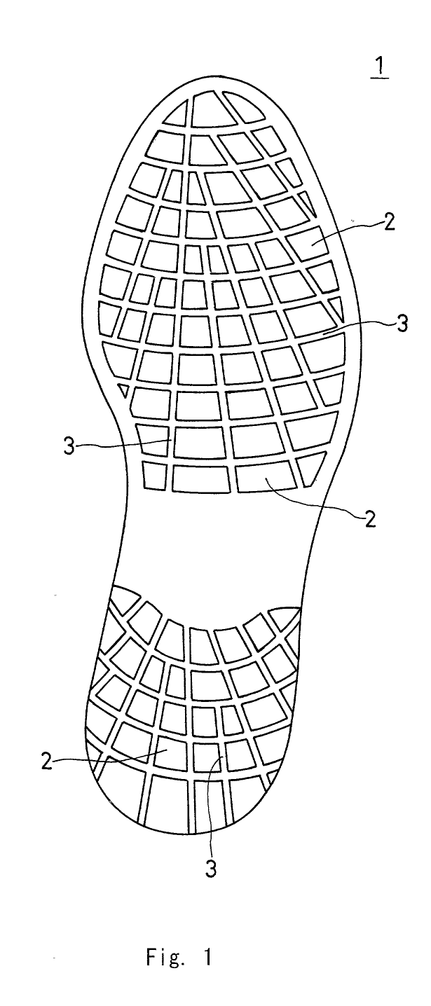

FIG. 1 is a bottom view showing an outsole 1 according to an embodiment of the present invention. The outsole 1 comprises a projection 2 on a bottom face. The bottom face has a concave portion 3 other than the projection 2. FIG. 1 shows only the outsole 1 for a left foot, and an outsole for a right foot has a shape obtained by inverting the shape shown in FIG. 1 in a transverse direction. An upper, an insole and the like which are well known are attached to the outsole 1, thereby constituting a shoe.

The outsole 1 is formed by crosslinking a rubber composition. A natural rubber, a styrene-butadiene rubber, a butadiene rubber, an isoprene rubber, a butyl rubber, an acrylonitrile-butadiene rubber, a chloroprene rubber, an ethylene-propylene-diene rubber, an acryl rubber, an epichlorohidrin rubber, a polysulfide rubber, an urethane rubber and the like can be used as a base rubber for the rubber composition. These base rubbers may be used separately or two of them or more may be used together. A particularly suitable base rubber includes a natural rubber, a styrene-butadiene rubber, a butadiene rubber, an isoprene rubber, a butyl rubber and an acrylonitrile-butadiene rubber. Moreover, a synthetic resin or a thermoplastic elastomer may be used as a base polymer in place of the rubber or together with the rubber.

A crosslinking agent, a filler, a softening agent, an antioxidant, a silanizing agent, a silane coupling agent, a vulcanization accelerator, an activator, a coloring agent or the like may be properly blended with the rubber composition. Silica, carbon black, calcium carbonate, clay and the like can be used as the filler. In particular, the silica and the carbon black which are excellent in reinforcing effects are preferable.

A short fiber is blended with the rubber composition. The short fiber has a fiber length of 10 mm or less. In respect of the compatibility of reinforcing effects with dispersibility, it is preferable that a short fiber having a fiber length of 0.2 mm to 5 mm should be used.

A material of the short fiber is not particularly restricted but a glass fiber, an aramid fiber, a carbon fiber, a polyamide fiber, a polyester fiber, a rayon fiber, a vinylon fiber, a cotton fiber and the like can be used, for example. The particularly suitable short fiber includes the glass fiber and the aramid fiber. Since the glass fiber is comparatively rigid, the degree of design freedom of bending anisotropy which will be described below in detail can be enhanced through the use of the glass fiber. The aramid fiber has a high fiber strength, the abrasion resistance of the outsole 1 can be enhanced through the use of the aramid fiber.

The short fiber has an orientation in a specific direction which is an almost horizontal direction (that is, a direction of a ground face of the outsole 1). Consequently, a tensile strength in the horizontal direction of the outsole 1 can be enhanced. From the viewpoint of an enhancement in the strength, it is preferable that an orientation angle to the horizontal direction of the short fiber should be 30 degrees or less, particularly 25 degrees or less, and furthermore 20 degrees or less.

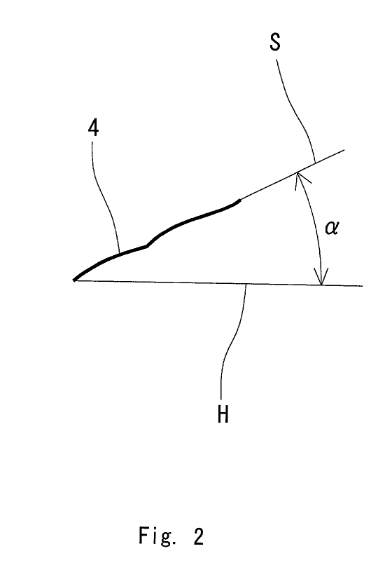

FIG. 2 is a typical diagram showing a method of measuring a fiber angle in the horizontal direction of a short fiber 4. In the case in which the short fiber 4 is regarded as a line segment, the measurement is carried out on a vertical plane including the line segment. As is apparent from FIG. 2, a horizontal line H passing through the left end of the short fiber 4 is first assumed for the measurement of the fiber angle. Next, a line segment S obtained by extending the short fiber 4 is assumed. A value (an absolute value) of an angle α formed by the horizontal line H and the line segment S is measured and the angle α is set to be the fiber angle in the horizontal direction. The fiber angle α has a maximum value of 90 degrees and a minimum value of 0 degree. An image enlarged by a microscope or the like is used for the measurement. A mean value of the fiber angles α thus measured is calculated to be an orientation angle.

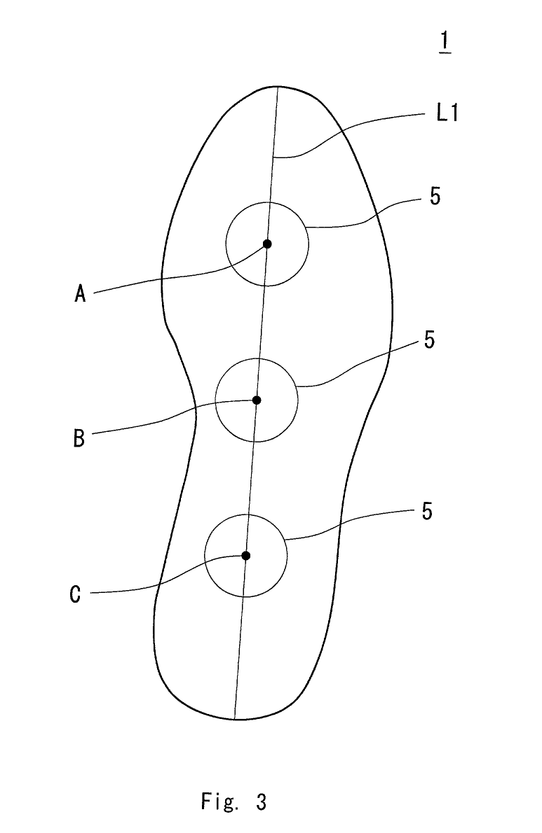

A method of calculating the orientation angle (a mean fiber angle) will be described below in detail. FIG. 3 is a typical bottom view showing the outsole 1 illustrated in FIG. 1. In FIG. 3, the projection 2 and the concave portion 3 are omitted. For the calculation of the orientation angle, first of all, a length line L1 is assumed. The length line L1 is the greatest in line segments having both ends positioned on the contour of the outsole 1. Next, three points A, B and C for dividing the length line L1 into four equal parts are assumed. Subsequently, a cylinder 5 setting the points A, B and C to be the centers of the bottom face is punched out of the outsole 1. The bottom face of the cylinder 5 has a diameter of 3 cm.

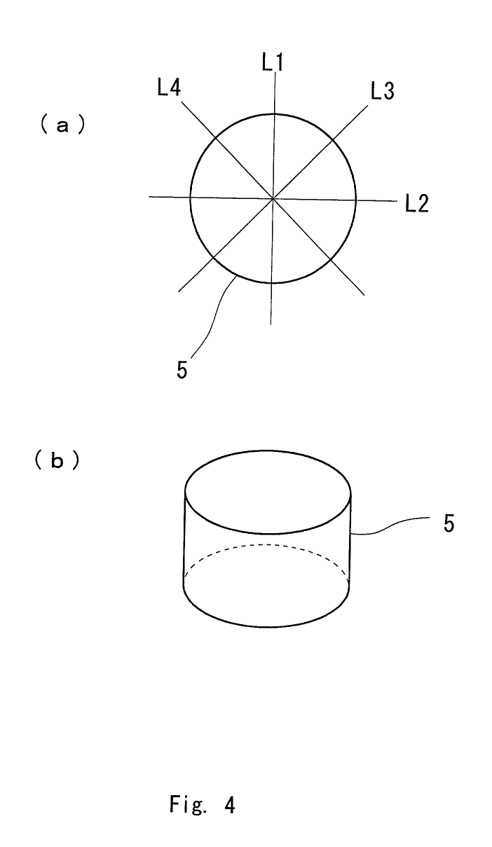

FIG. 4A is a bottom view showing the cylinder 5 punched out of the outsole 1 illustrated in FIG. 3, and FIG. 4B is a perspective view showing the cylinder 5. The cylinder 5 is divided into eight equal parts along the length line L1, a width line L2 orthogonal to the length line L1 and line segments L3 and L4 intersecting the length line L1 at an angle of 45 degrees. Thus, eight specimens are formed.

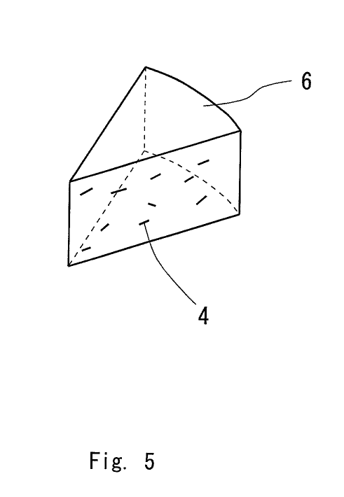

FIG. 5 is a perspective view showing a specimen 6 obtained from the cylinder 5 illustrated in FIGS. 4A and 4B. The short fiber 4 is observed on the broken section of the specimen 6. The short fiber 4 to be picked up over almost the whole length is selected, and the fiber angle α to the horizontal direction is measured for all the short fibers 4. One specimen 6 has two broken sections. Therefore, the fiber angle α is measured on 16 broken sections of one cylinder 5. Moreover, three cylinders 5 are punched out of one outsole 1 (on the left side or the right side), so the fiber angle α is measured on 48 broken sections of the outsole 1. A mean value of the fiber angle α measured on the 48 broken sections is set to be an orientation angle.

The amount of the short fiber 4 to be blended is 2 to 40 parts by weight for 100 parts by weight of a base polymer. In some cases in which the amount of the short fiber 4 to be blended is less than 2 parts by weight, a tensile strength in the horizontal direction of the outsole 1 might be insufficient. From this viewpoint, it is preferable that the amount of the short fiber 4 to be blended should be 3 parts by weight or more, particularly 5 parts by weight or more. In some cases in which the amount exceeds 40 parts by weight, the abrasion resistance of the outsole 1 might be deteriorated. From this viewpoint, it is preferable that the amount of the short fiber 4 to be blended should be 35 parts by weight or less, particularly 30 parts by weight or less.

While the short fiber 4 has an orientation in the almost horizontal direction as described above, a two-dimensional orientation on a horizontal plane onto which the whole shape of the short fiber 4 is projected is not particularly restricted. For example, the two-dimensional orientation may be a longitudinal direction (a direction of the line segment L1 in FIG. 3), a lateral direction (a direction orthogonal to the line segment L1 in FIG. 3) or an oblique direction. Moreover, the short fiber 4 does not have a two-dimensional orientation but may be arranged randomly.

In the outsole 1 in which the two-dimensional orientation is set to be the almost lateral direction, bending is caused with difficulty in the lateral direction because of the short fiber 4. On the other hand, a bending property in the longitudinal direction is rarely affected by the short fiber 4. In other words, the outsole 1 has a bending anisotropic property. A shoe comprising the outsole 1 provides a good wear feeling because the outsole 1 is greatly bent to fit human feet during forward walking. Moreover, since the outsole 1 is bent with difficulty during sliding in the lateral direction in sports, a high stability can be obtained.

In the outsole 1 setting the two-dimensional orientation to be the almost lateral direction, it is preferable that the orientation angle of the short fiber 4 to the lateral direction should be 30 degrees or less, particularly 25 degrees or less, and furthermore 20 degrees or less. Consequently, the wear feeling is more compatible with the stability.

The outsole 1 setting the two-dimensional orientation to be the almost longitudinal direction is excellent in a tensile strength in the longitudinal direction. Accordingly, also in the case in which a light material having a poor strength is used for the outsole 1, the strength is complemented by the short fiber 4 and the outsole 1 is broken with difficulty even if repetitive walking is carried out. In other words, the outsole 1 can achieve the compatibility of the strength with the light weight.

In the outsole 1 setting the two-dimensional orientation to be the almost longitudinal direction, it is preferable that the orientation angle of the short fiber 4 to the longitudinal direction should be 30 degrees or less, particularly 25 degrees or less, and furthermore 20 degrees or less in respect of the strength.

The outsole 1 setting the two-dimensional orientation to be an oblique direction (an almost intermediate direction between the lateral direction and the longitudinal direction) is excellent in a tensile strength in the oblique direction. The outsole 1 in which the short fiber 4 does not have a two-dimensional orientation is excellent in a balance the tensile strengths between the lateral, longitudinal and oblique directions.

A method of manufacturing the outsole 1 according to the present invention will be described below. First of all, a rubber composition having the short fiber 4 blended therewith is kneaded by means of a roll so that a thin sheet is formed. In the sheet, the short fiber 4 has an orientation in a sheet discharging direction (that is, a roll rotating direction). A preformed member having a shape similar to the outsole 1 can be obtained from the sheet through punching. The preformed member is put in a mold and is crosslinked by heating and pressurization. Thus, the outsole 1 is obtained. In the outsole 1, the sheet discharging direction is set to be the horizontal direction. Therefore, the orientation of the short fiber 4 is almost horizontal. The orientation angle can be regulated by controlling shearing force applied to the rubber composition during the kneading.

If the sheet discharging direction is set to be the lateral direction when the preformed member is to be punched, it is possible to obtain the outsole 1 in which the orientation of the short fiber 4 is set to be almost the horizontal and lateral directions. If the sheet discharging direction is set to be the longitudinal direction when the preformed member is to be punched, it is possible to obtain the outsole 1 in which the orientation of the short fiber 4 is set to be almost the horizontal and longitudinal directions. Furthermore, if the sheet discharging direction is set to be the oblique direction when the preformed member is to be punched, it is possible to obtain the outsole 1 in which the orientation of the short fiber 4 is set to be the almost horizontal direction and an oblique direction.

Even if an extruding method is employed in place of such a rolling method, the short fiber 4 has an orientation. In the case of the extruding method, the short fiber 4 has an orientation in an extruding direction. Therefore, the preformed member is obtained such that the extruding direction is set to be a horizontal direction.

### EXAMPLES

### Experiment 1

### Example 1

80.0 parts by weight of a styrene-butadiene rubber (trade name of “Nipol NS -116” produced by Nippon Zeon Co., Ltd.), 20.0 parts by weight of a butadiene rubber (trade name of “BR11” produced by JSR Corporation), 10 parts by weight of a glass fiber having a length of 3 mm (trade name of “microglass chopped strand” produced by Nippon Glass Fiber Co., Ltd.), 55.0 parts by weight of silica (trade name of “Ultrazil VN3” produced by Degussa Co., Ltd.), 5.5 parts by weight of a silane coupling agent (trade name of “Si69” produced by Degussa Co., Ltd.), 3.0 parts by weight of a softening agent (trade name of “PW380” produced by Idemitsu Kosan Co., Ltd.), 2.0 parts by weight of 2, 6-di-tert-butyl-4-methylphenol (trade name of “Nocrac 200” produced by Ouchi Shinko Kagaku Kogyo Co., Ltd.) as an antioxidant, and 0.5 part by weight of another antioxidant (trade name of “Sunnoc N” produced by Ouchi Shinko Kagaku Kogyou Co., Ltd.) were kneaded by means of an internal mixer. The kneaded substance was put in a roll, and furthermore, 3.0 parts by weight of zinc oxide, 1.0 part by weight of stearic acid, 1.0 part by weight of sulfur, 1.0 part by weight of N-tert-butyl-2-benzothiazolyl sulfenamide (trade name of “NoccelerNS” produced by Ouchi Shinko Kagaku Kogyou Co., Ltd.) as a vulcanization accelerator, 0.5 part by weight of zinc diethyldithiocarbamate (trade name of “Nocceler EZ” produced by Ouchi Shinko Kagaku Kogyou Co., Ltd.) as another vulcanization accelerator, and 0.5 part by weight di-orthotoeyeguanidine (trade name of “Nocceler DT” produced by Ouchi Shinko Kagaku Kogyou Co., Ltd.) as a further vulcanization accelerator were added thereto and were kneaded. Thus, a rubber composition was obtained. The rubber composition was discharged like a sheet from the roll.

The sheet thus obtained is punched to have almost the same shape as an outsole. Consequently, a preformed member was obtained. For the punching, the sheet discharging direction was set to a lateral direction. The preformed member was put in a mold and was heated and pressurized for 10 minutes at a temperature of 160° C. Thus, an outsole according to an example 1 was obtained. An orientation angle to a horizontal direction of the outsole was 5.1 degrees.

### Examples 2 and 3

Outsoles according to examples 2 and 3 were obtained in the same manner as the example 1 except that shearing force applied to a rubber composition was varied during kneading in a roll. Orientation angles to a horizontal direction of the outsoles are shown in the following Table 1.

### Example 4 and Comparative Examples 1 and 2

Outsoles according to an example 4 and a comparative example 2 were obtained in the same manner as the example 1 except that the amount of a glass fiber to be blended was set as shown in the following Table 1. Moreover, an outsole according to a comparative example 1 was obtained in the same manner as the example 1 except that the glass fiber was not blended at all.

### Example 5

An outsole according to an example 5 was obtained in the same manner as the example 1 except that an aramid fiber having a fiber length of 0.5 mm (trade name of “Kebler (R) produced by Du Pont Kabushiki Kaisha (“Kebler (R) is a trademark of Du Pont Kabushiki Kaisha)) was used in place of the glass fiber.

### Evaluation of Function

An upper and an insole which are well known were attached to the outsole according to each of the examples and the comparative examples. Thus, a shoe was obtained. Ten testers wore the shoes to carry out forward walking and sliding in a transverse direction. A bending property obtained during the forward walking and a stability obtained during the sliding were evaluated in five stages of “1” to “5”. The lowest evaluation value is set to “1” and the highest evaluation value is set to “5”. A mean evaluation value is shown in the following Table 1.

### Measurement of Tensile Strength in Lateral Direction

The outsole according to each of the examples and the comparative examples was sliced so that a plate-shaped member having a thickness of 2 mm was obtained. The plate-shaped member was punched to have the shape of JIS-No. 3 Dumbbell. Thus, a specimen was obtained. A direction of tension of the specimen was caused to be coincident with the lateral direction. The specimen was subjected to a tension test in accordance with JIS-K-6251 to measure a tensile strength. The result of the measurement is shown in the following Table 1.

### Evaluation of Abrasion Resistance

The rubber composition sheet used for the outsole according to each of the examples and the comparative examples was put in a mold and was heated and pressurized for 15 minutes at a temperature of 160° C. Thus, a disk-shaped specimen having a thickness of 12.7 mm was obtained. The specimen was subjected to an Akron abrasion test in accordance with JIS-K-6264 to measure an abrasion capacity. The result of the measurement is shown in the following Table 1.

TABLE 1
Result of Experiment 1

| | Com. Ex. 1 | Ex. 1 | Ex. 2 | Ex. 3 | Ex. 4 | Com.Ex. 2 | Ex. 5 |
|---|---|---|---|---|---|---|---|
| Glass fiber (part) | — | 10 | 10 | 10 | 35 | 45 | — |
| Aramid fiber (part) | — | — | — | — | — | — | 10 |
| Orientation angle | — | 5.1 | 24.9 | 35.0 | 5.3 | 5.3 | 5.0 |
| (degree) | | | | | | | |
| Two-dimensional | — | lateral | lateral | lateral | lateral | lateral | lateral |
| orientation | | direction | direction | direction | direction | direction | direction |
| Bending property | 3.7 | 3.9 | 3.2 | 2.5 | 3.8 | 3.7 | 3.8 |
| Stability | 1.1 | 3.9 | 3.7 | 2.9 | 4.4 | 4.6 | 3.6 |
| Lateral tensile | 12 | 18 | 17 | 16 | 20 | 21 | 17 |
| strength (MPa) | | | | | | | |
| Abration capacity | 0.10 | 0.31 | 0.31 | 0.32 | 0.65 | 1.06 | 0.22 |
| (cm³) | | | | | | | |

From the Table 1, it is apparent that the outsole according to each of the examples is more excellent in the stability and the lateral strength than that according to the comparative example 1. Moreover, it is apparent that the outsole according to each of the examples is more excellent in the abrasion resistance than that according to the comparative example 2.

### Experiment 2

### Examples 6 and 7

An outsole according to an example 6 was obtained in the same manner as the example 1 except that a sheet discharging direction was caused to be coincident with a longitudinal direction when a sheet was to be punched out to obtain a performed member. Moreover, an outsole according to an example 7 was obtained in the same manner as the example 1 except that a sheet discharging direction was caused to be coincident with an oblique direction when a sheet was to be punched out to obtain a performed member.

### Example 8

An outsole according to an example 8 was obtained in the same manner as the example 1 except that a sheet to be discharged from a roll had almost a half thickness, two sheets were superposed to have sheet discharging directions orthogonal to each other and a preformed member was punched out. In the outsole, a short fiber does not have a two-dimensional orientation (randomly).

### Measurement of Tensile Strength

The outsoles according to the sixth to eighth examples thus obtained were subjected to the tension test in accordance with the JIS-K-6251 together with the outsoles according to the example 1 and the comparative example 1 in the experiment 1. Three kinds of dumbbell specimens were fabricated such that a direction of tension is coincident with a lateral direction, a longitudinal direction and an oblique direction and a tensile strength was measured for each of them. The result of the measurement is shown in the following Table 2.

TABLE 2
Result of Experiment 2

| | Com. Ex. 1 | Ex. 1 | Ex. 6 | Ex. 7 | Ex. 8 |
|---|---|---|---|---|---|
| Glass fiber (part) | — | 10 | 10 | 10 | 10 |
| Orientation angle (degree) | — | 5.1 | 5.1 | 5.1 | 4.9 |
| Two-dimensional | — | lateral | longitudinal | oblique | random |
| orientation | | direction | direction | direction | |

| | | | | | | |
|---|---|---|---|---|---|---|
| Tensile | Lateral direction | 12 | 18 | 15 | 16 | 17 |
| strength | Longitudinal direction | 12 | 15 | 18 | 16 | 17 |
| (MPa) | Oblique direction | 12 | 16 | 16 | 18 | 17 |

From the Table 2, it is apparent that the outsole according to the example 1 is excellent in the strength in the lateral direction, the outsole according to the example 6 is excellent in the strength in the longitudinal direction and the outsole according to the example 7 is excellent in the strength in the oblique direction. Moreover, it is apparent from the Table 2 that the outsole according to the eighth example is excellent in a balance of the strength in each of the directions.

The above description is only illustrative and can be variously changed without departing from the scope of the invention.

What is claimed is:

1. An outsole formed of a polymer composition having 2 to 40 parts by weight of a short fiber blended for 100 parts by weight of a base polymer, the short fiber having an orientation in an almost horizontal direction.

2. The outsole according to claim 1, wherein the short fiber is a glass fiber or an aramid fiber.

3. The outsole according to claim 1, wherein the short fiber has an orientation in almost horizontal and lateral directions.

4. The outsole according to claim 1, wherein the short fiber has an orientation in almost horizontal and longitudinal directions.

5. The outsole according to claim 1, wherein the short fiber has an orientation angle of 30 degrees or less to a horizontal direction.

6. The outsole according to claim 1, wherein the short fiber has an orientation angle of 25 degrees or less to a horizontal direction.

7. An outsole formed of a polymer composition which is caused to have a shape of a sheet through extrusion or rolling and includes a short fiber having an orientation in a specific direction, the orientation being almost coincident with a lateral direction.

8. An outsole formed of a polymer composition which is caused to have a shape of a sheet through extrusion or rolling and includes a short fiber having an orientation in a specific direction, the orientation being almost coincident with a longitudinal direction.

9. A shoe comprising an outsole formed of a polymer composition having 2 to 40 parts by weight of a short fiber blended for 100 parts by weight of a base polymer, the short fiber having an orientation in an almost horizontal direction.

10. A shoe comprising an outsole formed of a polymer composition which is caused to have a shape of a sheet through extrusion or rolling and includes a short fiber having an orientation in a specific direction, the orientation being almost coincident with a lateral direction.

11. A shoe comprising an outsole formed of a polymer composition which is caused to have a shape of a sheet through extrusion or rolling and includes a short fiber having an orientation in a specific direction, the orientation being almost coincident with a longitudinal direction.
